(19) United States
(12) Patent Application Publication
(10) Pub. No.: US 2008/0195520 A1
(43) Pub. Date: Aug. 14, 2008

(54) FLIPPING PRODUCTS BETWEEN PLATFORMS

(76) Inventors: Nancy J. Rabenold, Brandon, FL (US); James A. Simmons, Brandon, FL (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/672,988

(22) Filed: Feb. 9, 2007

(51) Int. Cl. G06Q 30/00

(52) U.S. Cl. 705/37

(57) ABSTRACT

Products obtained on one network based platform can be flipped to another network based platform for resell. A party logs on to an online auction system to participate in an auction. If the party wins the product, the party may then manually or automatically have the product re-listed on another platform (or in some circumstances the same platform) to be sold once again. The auction winner can select one or more destination platforms on which to list the product. For each platform, descriptive information about the product is obtained using a variety of techniques and then provided to the destination platform for the listing of the product. The descriptive information can be obtained from the information available in the acquiring platform, public records such as though available over the Internet, database records, interpretation of serial numbers or VIN numbers, user profile information, information directly entered by the winner of the auction or other parties, etc. The descriptive information is converted to a format that is compatible with the destination platform.

### CROSS-REFERENCE TO RELATED APPLICATIONS

This application incorporates by reference U.S. Pat. No. 6,813,612 issued on Nov. 2, 2004.

### BACKGROUND OF THE INVENTION

In a January 2005 article by Frank Fortunato entitled “Welcome to the Jungle: The Two Sides of eBay”, it was reported that “eBay claims that 430,000 people earn a living on the site” (meaning at ebay.com). And although eBay is the big-boy on the block when it comes to consumer based, on-line auctions, they are not the only players that are experiencing an incredible amount of success in the industry. Other well known participants in the industry include Yahoo and Amazon.com. But that is just the beginning, there are online auctions available from an incredibly large list of participants, only some of which include uBid.com, shopgoodwill.com, auctionfire.com, bid-alot.com, webidz.com, buyselltrades.com, onlineauction.com, Sams Club, and shopzilla.com. In fact, at the time of authoring this background, a GOOGLE search of “online auctions” returns over 52 million hits. The Internet and online auctions has changed the way we shop and have created viable jobs for many individuals and small businesses.

However, as in most businesses, profits can be increased by moving more products faster. Certainly many other business principles also apply to the online auction industry, such as “buy low and sell high” and “strike while the iron is hot”. As such, in the online auction industry, many participants actually look for bargains that they can easily turn-around in another auction in an effort to make a profit. This action is termed in the industry as “flipping”. This term has been used for many years in many selling industries including real-estate. In addition, many successful online auction sellers also seek bargains outside the online auction arena to obtain product that can be profitably sold in an online auction. In both of these scenarios, the online auction seller must obtain the product, categorize the product, and enter the product descriptions and particulars into an appropriate online auction interface. For high-volume companies, this can be a tedious and time-consuming task. As such, many companies that move a significant amount of product through online auctions find it necessary to hire staff for entering data into the online auctions and monitoring the auction activity. However, in many circumstances, product obtained from one auction, on-line store, or other sources may already have pertinent information available online and rather than re-keying that information into an online auction, it is desirable for this information to be transferred from one source to another.

As was uttered by the Captain in movie Cool Hand Luke “what we have here is a failure to communicate”. This is a hurdle that needs to be overcome to provide for the seamless flipping of product acquired through one auction or online source to another auction or online source. The communication not only requires a medium, but also a common language. One viable medium in this scenario is obviously the Internet and thus, the main problems associated with meeting this need in the art includes the existence of a common language and an opportunity to communicate. Thus, there is a need in the art for a solution that enables acquirers of product through online sources to flip or transition the products to another platform. Any automation that can be incorporated into this process can greatly impact the ability to move product faster, and as such, improve a company's profits.

Another auctioning market that has heavily delved into the online arena is the traditional type auctions that have utilized the Internet to enable remote bidders to participate in a live auction as though they were actually present. Auction Management Solutions is a leading provider of technology that enables this functionality. One of the products offered by Auction Management Solutions is their ONLINE RINGMAN product which enables an auctioneer to control a live auction and manage the pace of the auction, as well as interact with remote bidders in a manner that can make them feel as though they are a part of the auction. In many of the auctions that are run using the ONLINE RINGMAN system, as well as similar systems, the information about the lot or product being bid on is available online. Once an auctioning event is completed, the information about the auctioning event, the winning party, etc., is also available online. Many times, the bidding participants at such auctions are attempting to acquire product to sell in other arenas. Thus, there is a need in the art for a solution that would enable such bidding participants to easily transfer the products won in one of these auctions, to a different platform or arena for resell or re-auctioning.

### BRIEF SUMMARY OF THE INVENTION

In general, the embodiments of the present invention enable a purchaser or acquirer of product to flip this product onto another platform in an effort to resell the product. More specifically, one embodiment of the present invention enables the winner of an on-line auction to flip the product to another electronic, network based market place. As an example, a party may log on to an online auction system to participate in an auction. At the time the auction closes, if the party is the high bidder, then the party wins the auction and can take possession of the product. However, rather than physically taking possession of the product, or in addition thereto, the party may then manually or automatically have the product re-listed on another platform (or in some circumstances the same platform) to be sold once again. The auction winner can select one or more destination platforms on which to list the product. For each platform, descriptive information about the product is obtained using a variety of techniques and then provided to the destination platform for the listing of the product. The descriptive information can be obtained from the information available in the acquiring platform, public records such as though available over the Internet, database records, interpretation of serial numbers or VIN numbers, user profile information, information directly entered by the winner of the auction or other parties, etc. In some embodiments, the descriptive information is converted to a format that is compatible with the destination platform.

One embodiment of the present invention operates to facilitate the reselling of acquired products. When a product is acquired, such as by winning an auction, descriptive elements, or information about the acquired product, are identified. The descriptive elements are then formatted in accordance or compatible with a destination platform. The formatted descriptive elements are then transmitted to the destination platform and the product is listed on the destination platform. Furthermore, embodiments of the present invention may accept flipping profile information that identifies products or classes of products that are qualified for being flipped. This information may identify products by categories, part-numbers, etc. and may also identify one or more platforms on which to resell the products.

The descriptive elements or information may be obtained in a variety of manners. Non-limiting examples include scraping a displayed screen to obtain the descriptive elements, searching the Internet for further identifying information, soliciting information from the acquiring party, and accessing a database containing product descriptive information.

The invention may be implemented within the acquiring platform, within the destination platform, within a device external to both the acquiring platform and the destination platform, or in a combination of two or more of these. In either scenario, the descriptive information on the acquiring platform must be formatted to be compatible with the destination platform. In one embodiment an intermediary may receive the descriptive information in one format and then convert it to another format before sending it to the destination. In another embodiment, the information may be converted at the acquiring platform and the directly transferred to the destination platform. In yet another embodiment, the destination platform or an intermediary may access the acquiring platform to obtain the descriptive information.

The information can be transferred in a variety of manners including FTP transfers, email transfers, SMTP transfers, proprietary protocols and data structures, or any of a variety of other techniques.

In another embodiment of the invention, a system may be used to facilitate re-listing of acquired products. The system may include and acquiring platform interface, a destination platform interface and a flipping engine that communicates with the acquiring platform and the destination platform through the respective interfaces. This embodiment of the present invention is operable detect the acquisition of an item or to be informed that an item has been acquired. Information about the product is obtained from the acquiring platform or other sources, formatted to be compatible with the destination platform(s) and then provided to the destination platform through the destination platform interface.

### BRIEF DESCRIPTION OF THE SEVERAL VIEWS OF THE DRAWING

FIG. 1 is a block diagram of an exemplary integrated live auction environment and online auction environment suitable for various embodiments of the present invention.

FIG. 2 is a block diagram illustrating a high-level description of an environment suitable for embodiments of the present invention.

FIG. 3 is a screen shot of an item available for bid during a scheduled Ritchie Brothers Auction.

FIG. 4 is a screen shot of a form presented on the TRACTORHOUSE.COM website to a registered user that desires to list a product for sale.

FIG. 6 is a flow chart diagram illustrating the general steps or processes involved in an exemplary embodiment of the present invention.

### DETAILED DESCRIPTION OF THE INVENTION

Embodiments of the present invention, in general, are directed towards automatically or semi-automatically flipping items that were acquired or obtained from one platform, such as winning the item in an auction, onto a different platform for resell. Advantageously, embodiments of the present invention enable products to be acquired and sold in an expeditious and/or procedurally efficient and easy manner. In an exemplary embodiment of the present invention, items are acquired through one auctioning platform and then automatically made available on another auctioning platform. More specifically, such an exemplary embodiment could allow items purchased through a system such as Auction Management Solutions' ONLINE RINGMAN, whether purchased from the auction floor or through a remote bidder operating on the Internet, to automatically, or semi-automatically, move these items to another platform, such as eBay, and make them available for resell through an online market or other listing mechanism. However, other embodiments allow for items purchased from a variety of different platforms to also be flipped onto another platform, or even in some embodiments to be flipped right back onto the same platform.

For instance, another embodiment of the present invention provides a solution to the afore mentioned needs in the art, as well as other needs by enabling the flipping of items that are obtained via one platform or arena onto a different platform or arena, with the arenas either being online arenas or including an online interface. More specifically, one embodiment of the present invention enables an acquirer of product obtained through an online supported auction to automatically flip that product onto a different platform. Advantageously, this aspect of the present invention enables the acquirer to quickly move inventory won or acquired through one arena, through a different or same arena. This is generally accomplished by identifying a destination platform for items acquired or won, determining the information required to list the products on that platform, identifying the format for such required information, converting the information available on the platform from which the products are acquired to the format for the destination platform, filling in or obtaining missing information and then engaging the destination platform for the sell of the products.

Now, turning to the figures, various aspects, features, embodiments and advantages of the present invention will be more fully described.

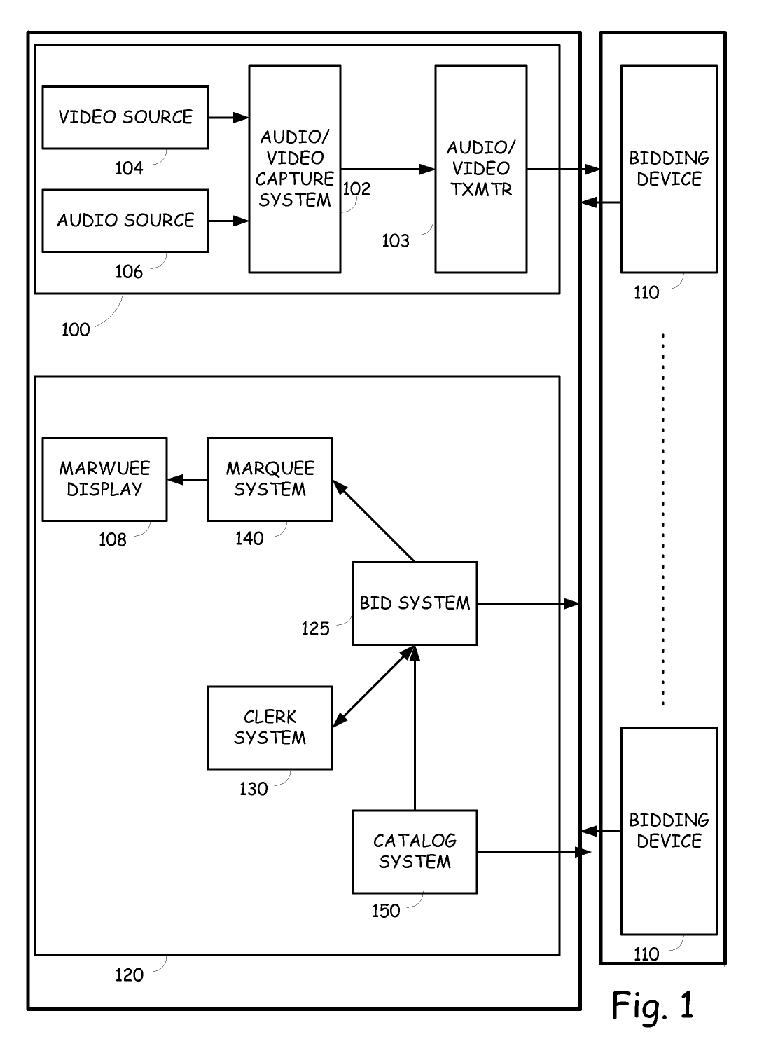

FIG. 1 is a block diagram of an exemplary integrated live auction environment and online auction environment suitable for various embodiments of the present invention. In the illustrated environment, the system includes:

An audio/video system 100 for delivering live audio and video feeds from the auction floor to the remote bidders;

One or more bidding devices 110 used by the remotely participating bidders to, among other things, monitor various auctions, bid on various items and render the audio and video information to the bidder; and

A bid processing system 120 that operates to control the interaction among the remote bidders, a clerk and/or an auctioneer and the local bidders attending the auction.

In an exemplary embodiment, the audio/video system 100 includes a video source 104, an audio source 106, and an audio/video capture system 102, all of which are typically located at the auction site and an audio/video transmitter 103 for providing the audio and video signals to the one or more bidding devices 110. The audio/video system 100 operates to receive an audio and/or video stream from the audio/video capture system 102, provide the encapsulated data to the audio/video transmitter 103 and then to deliver this data to one or more bidder devices 110. The audio/video capture system 102 can be implemented in a variety of manners, one of which may consist of suitable hardware cards installed in a computer system. The audio/video capture system 102 encapsulates the audio/video stream from the auction floor by interfacing to the audio source 106 and/or the video source 104. The audio/video system 100 operates to gather this audio and/or video data and transmit or broadcast the data in an appropriate format to one or more of the bidder devices 110. Further details of one embodiment of the audio/video system 100 can be found in U.S. Pat. No. 6,813,612; however, it will be appreciated that many other embodiments can be utilized in various implementations of the present invention and in addition, aspects and features of the present invention may be incorporated into a system that does not provide audio, video or both.

The bid processing system 120 may take on a variety of embodiments, such as those disclosed in U.S. Pat. No. 6,813,612, and/or encapsulated in the ONLINE RINGMAN system developed and marketed by Auction Management Solutions of Tampa Fla., as well as other similar systems. For illustrative purposes, a non-limiting example of a suitable bid processing system 120 may include a bid system 125 and a clerk system 130. Data for an item to be sold in the auction can be extracted from a catalog system 150 that maintains the pre-sales information prior to the auction start, and transferred to the bid system 125, and broadcast to various bidder devices 110 bidding participants, bid acceptance, etc. may be transmitted to the marquee system 140 and/or the bidder devices 110, and logs can be maintained identifying activity including the status of each bid made by a remote bidder or local bidder. The bid system 125 may include a “bid engine” algorithm to facilitate controlling the bidding process. The bid engine can be implemented to support one or more of the bidding models that function to control the bidding process. The various bidding models can be used to define the level of automation in the bidding process (i.e., whether the auctioneer is in total control of all aspects of the bidding process or if some of the functions are performed automatically outside of the auctioneers control), the bid increments, the ability to enter starting bids, display formats, etc. U.S. Pat. No. 6,813,612 defines four specific bidding models identified as the CHEROKEE, IROQUOIS, MOHAWK and APACHE models; however, other bidding models may also be utilized in conjunction with the various aspects and features of the present invention.

A detailed embodiment of an exemplary bidding device 110 is more fully described in U.S. Pat. No. 6,813,612, however, it should be appreciated that various aspects and features of the present invention can be realized in other embodiments of a bidding device. Basically, for various embodiments of the present invention, the bidding device simply needs to include a display or other user presentation interface, a user input interface, a bid processing system interface, a processing unit for executing a software or firmware process implementing the various steps involved in embodiments of present invention and optionally an audio output interface.

Aspects of the present invention can be implemented using a variety of hardware platforms, software languages and programming environments. Those skilled in the art will readily observe that implementing the present invention in various environments will naturally require the use of various technologies. However, the present invention is not limited to any particular division of hardware/software functionality, hardware components, software languages, or programming techniques. Thus, references within this description identifying design particulars, although in and of themselves may be considered novel and inventive, are provided primarily for illustrative purposes and should not be construed to limit the present invention but rather are additive.

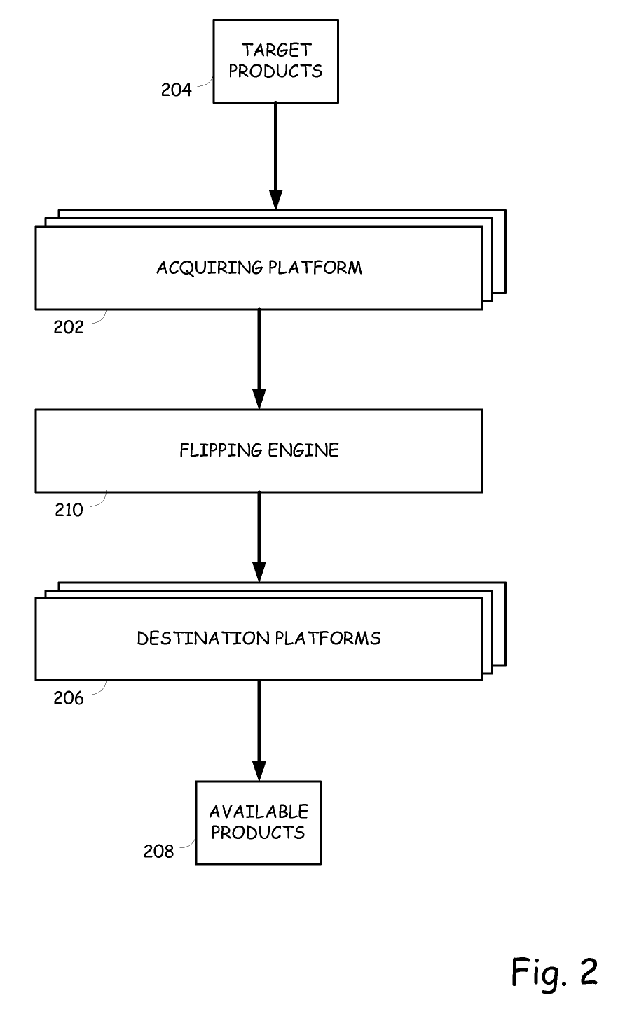

FIG. 2 is a block diagram illustrating a high-level description of an environment suitable for embodiments of the present invention. Acquiring platforms 202 are shown as providing availability or access to one or more target products 204. It will be appreciated that embodiments of the present invention may work with a single acquiring platform, multiple homogenous platforms or multiple heterogeneous platforms. Thus, the target products 204 may be similar or consistent across the embodiments, may be limited to a small subset of product types, or may range over an incredibly large number of classes and types. For instance, in an exemplary embodiment of the present invention the acquiring platforms 202 may include an online auctioning platform, an online retail store, a physical store that posts purchases to the Internet or sends confirmations via email, an online interface to a physical store, etc. In another embodiment, the acquiring platforms 202 may be multiple online systems that provide access to an auction house. For instance, ONLINE RINGMAN may host auctions in various auction houses and each auction house may represent a different acquiring platform 202. In the former example, a wide variety of target products 204 may be acquired whereas in the latter example, the target products 204 may be limited to automobiles or vehicles.

One or more destination platforms 206 may then be used to re-list or resell the target product(s) 204 acquired from the acquiring platform 202. Similarly, the destination platforms 206 may be a single platform, multiple homogenous platforms or multiple heterogeneous platforms. Regardless of the configuration, one or more of the target products 204 obtained from the one or more acquiring platforms 202 can be flipped to be available products 208 on the one or more destination platforms 206.

The flipping engine 210 is the element that enables target products 204 that are acquired through the one or more acquiring platforms 202 to be listed or made available on the one or more destination platforms 206 as available products 208. The flipping engine may take on a variety of embodiments including a stand alone system that is accessible via the Internet, software that is embedded in either the one or more acquiring systems or destination systems, or even distributed among both, as well as other embodiments. In general, the flipping engine 210 operates to identify or receive notification of target products 204 that are to be flipped to a destination platform 206, obtain or solicit the information required to flip the target product 204, and then make the target product 204 an available product 208 on one or more destination platforms 206. It will be appreciated that information available from the acquiring platform 202 may be different, deficient, superfluous, incompatible or otherwise inadequate to satisfy the requirements for listing the product on a destination platform 206. Yet, in other situations, the information available from an acquiring platform 202 pertaining to a target product 204 may be directly ported over to a destination platform 206 for an available product 208. Thus, the flipping engine 210 may take on a variety of capabilities depending upon various embodiments and various requirements imposed upon the embodiments. For example, in one embodiment, the flipping engine 210 may simply extract information from a form describing a target product and port that information into appropriate fields of a form describing the available product 208. However, in an alternate embodiment, the flipping engine may be required to perform one or more of the following actions, or even other actions that may become necessary: (a) extract information from a database, such as the catalog system 150 housing information about the seller of the available product 208; (b) solicit information from the seller through various means including emails, automated telephone calls, pages, mailing of postcards, requests made upon logging onto the system, etc.; (c) conduct an electronic search on the Internet for further information; (d) contact a product dealer for further information; and (e) contact the acquiring platform for further details.

As a particular example of an embodiment of the present invention, consider the acquisition of a tractor obtained by a participant in a Ritchie Brothers Auction provisioned by Auction Management Systems' ONLINE RINGMAN. The acquirer also desires to flip the acquired product to the online market of TRACTORHOUSE.COM located at www.tractorhouse.com. In general, the various embodiments of the invention operate to extract information from the acquiring platform 202 and then interject this information, either by itself or augmented with additional information, into the destination platform 206. The techniques employed for providing this general functionality can be quite varied.

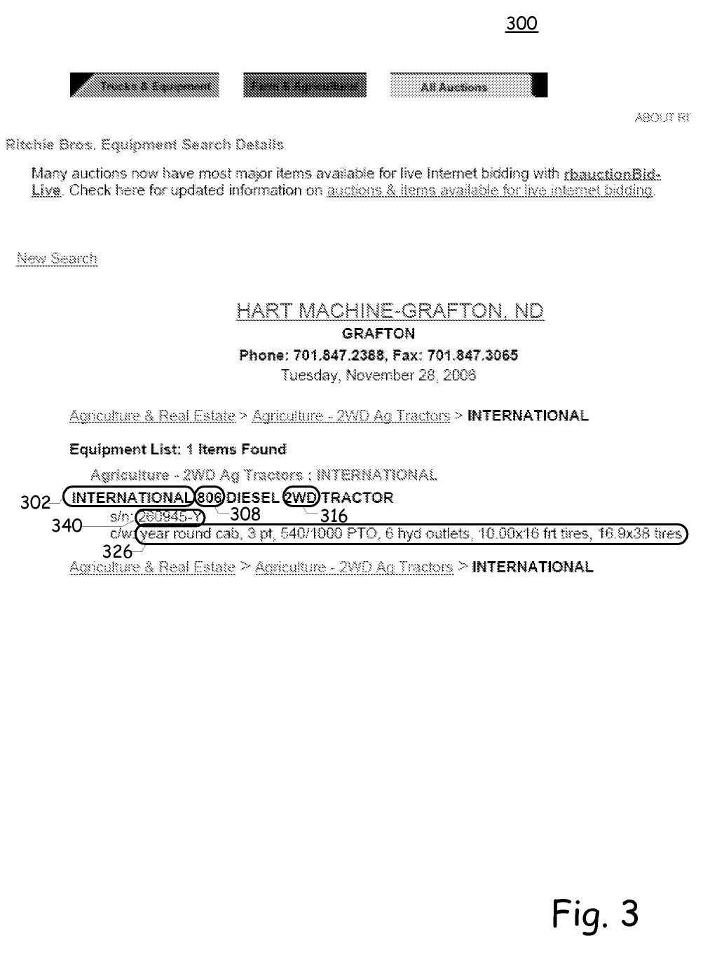

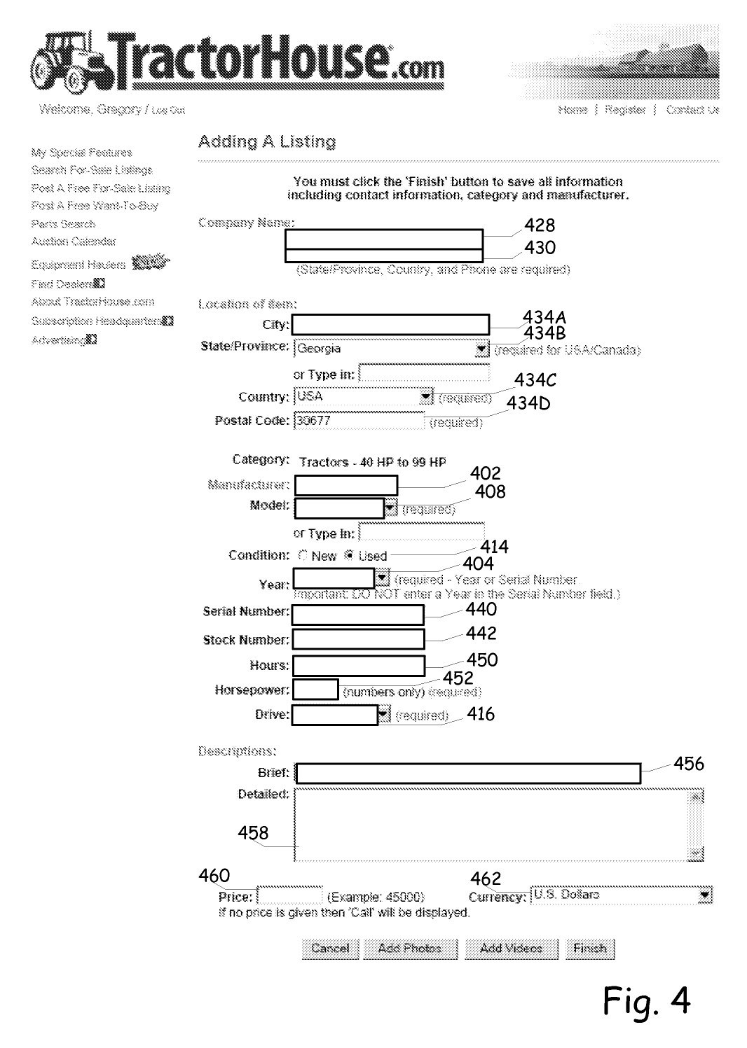

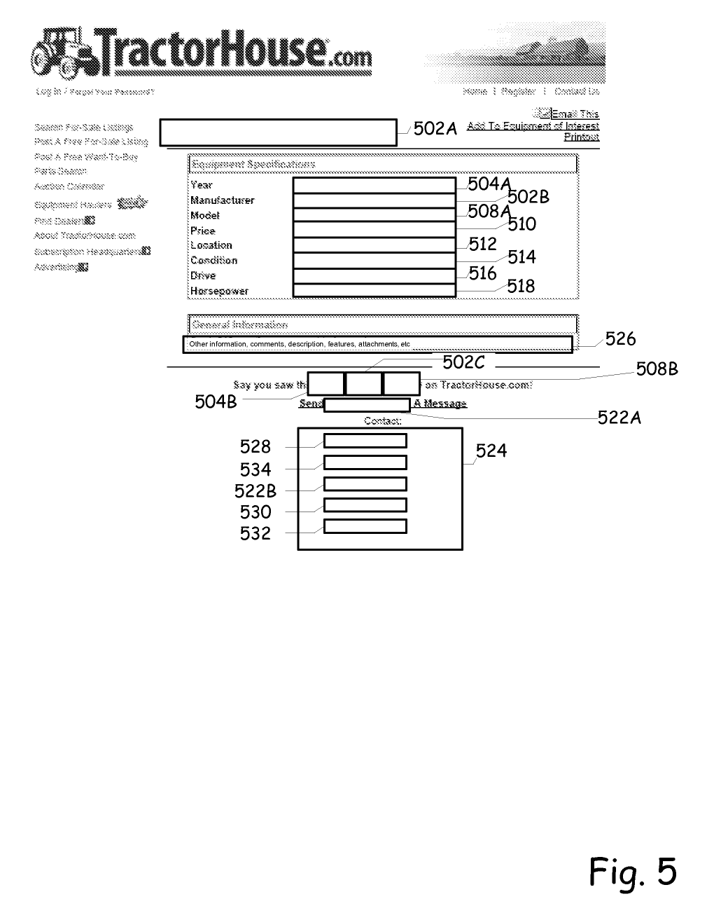

In one embodiment of the present invention, an external system can be used to fully implement functionality of the present invention in a non-intrusive manner. Thus, this embodiment of the present invention can operate without having to modify the existing acquiring and destination platforms. In this embodiment of the invention, the flipping engine 210 exists entirely external to the acquiring platform and the destination platform. This embodiment of the present invention is best illustrated by reference to FIGS. 3-5. FIG. 3 is a screen shot of an item available for bid during a scheduled Ritchie Brothers Auction. The screen shot 300 provides information regarding a target product 204 available on the Ritchie Brothers online auction platform that could represent a target product 204 to be flipped onto a destination platform 206. FIG. 4 is a screen shot of a form presented on the TRACTORHOUSE.COM website to a registered user that desires to list a product for sale. The screen shot 400 includes multiple fields to be completed for listing the product. Some of the fields are automatically populated by information about the user that is maintained by the website. Other fields may need to be entered as a product is registered or listed on the site. In general, this embodiment of the present invention gathers information extrinsically available without having to modify or intrude the acquisition platform and then, inserts this information into the destination platform in a standard fashion. Using an embodiment of this invention, when a product is acquired, such as the tractor shown in screen shot 300 of FIG. 3, the external system accesses the information available and displayed on the screen. The screen shot 300 of FIG. 3 includes the following information about the target product 204 that is being acquired:

the manufacturer of the tractor—International 302;

the model number of the tractor—806 308;

the drive train of the tractor—2 wheel drive (2WD) 316;

general descriptive information—year round cab, 3 pt, 540/1000 PTO, 6 hyd. outlets, 10.00×16 frt tires, 16.9×38 tires 326; and

the serial number of the tractor—260945-Y 34.

If this target product 204 is acquired, the external system then operates to list the product on the one or more destination platforms 206. The acquirer can interface to the external system prior to engaging in acquisition activity or, subsequent to acquiring products, and then notify the external system as to what destination platforms 206 are desired for the product. Alternatively, the external system can be set up to receive signals or indicators whenever the acquirer successfully acquires a product and then prompt the acquirer or solicit from the acquirer instructions regarding the destination platforms. Those skilled in the art will appreciate that many techniques, above and beyond what is described herein, can be used to (a) identify products that have been acquired and (b) identify the destination platforms for those products.

This embodiment of the present invention can obtain the target product 204 information by searching the content of the screen shot 300 for keywords and then scraping the screen to obtain the values associated with the keywords. For instance, the key word “s/n” can be searched for to find the serial number for the purchased tractor. In addition, the screen can be scraped and then parsed/analyzed to identify other product characteristics. If the external system identifies the word “International” on the screen 300, the external system can identify this as a tractor manufacturer from a list of known manufacturers. However, because a word such as “International” can potentially appear on the screen for other purposes than to identify a tractor manufacturer, the external system must also apply a level of intelligence to verify the use of the word. In the present example, the context of the word indicates that it is being used to identify the manufacturer of the tractor. Similarly, the other occurrences of the word “International” can also be used to apply intelligence in identifying the manufacturer of the product.

This embodiment of the present invention also operates to automate the process of entering this product onto the destination platform. The screen shot 400 in FIG. 4 is the user interface displayed over the Internet for a registered user wanting to enter a product on the TRACTORHOUSE.COM website. The form displayed in screen shot 400 includes multiple fields to be completed. The external system can operate to access the TRACTORHOUSE.COM website, login the registered user, and then automatically populate the form and submit it to the TRACTORHOUSE.COM website. Those skilled in the art will understand that the external system can perform this task in a variety of manners including, as a programmed “bot”, by editing the form fields on an HTML level and submitting the form, or using other techniques or a combination of one or more techniques. The information to be provided in screen shot 400 includes the following fields:
company name 428;
company address 430;
location of product city 434A;
location of product state 434B;
location of product country 434C;
location of product zip code 434D;
manufacturer 402;
model 408;
condition 414;
year 404;
serial number 440;
stock number 442;
hours 450;
horse power 452;
drive 416;
brief description 456;
detailed description 458;
price 460; and
currency 462.

A quick examination of the fields to be completed in the screen shot 400 shows that there is not a one-to-one correspondence with the information available from screen shot 300. In fact, the only direct correspondence is the following fields illustrated in Table 1.

TABLE 1

| Screen shot 400 | Screen shot 300 |
|---|---|
| manufacture 402 | manufacturer of the tractor 302 |
| model 408 | model number of the tractor 308 |
| drive 416 | drive train of the tractor 316 |
| serial number 440 | serial number 340 |
| brief description 456 | general descriptive information 326 |

However, the flipping engine can apply intelligence to further populate the fields of the form displayed in screen shot 400. For instance, the flipping engine can review the general description information 326 for keywords that may apply to the specific form fields of screen shot 400. In addition, the flipping engine may use the serial number to look up manufacturer information regarding the product. Thus, by accessing the manufacturer's information based on the serial number of the product, the flipping engine may be able to populate the following fields: manufacturer 402; model 408; year 404; horse power 452; drive 416; brief description 456; and detailed description 458.

Other information for the form may automatically be completed by the TRACTORHOUSE.COM platform or can be provided to the flipping engine as user profile information. For example, when a user registers with TRACTORHOUSE.COM, certain information is required. This information includes address and contact information for the listing party as well as other similar information. Thus, this information can be automatically filled in by the TRACTORHOUSE.COM platform. The flipping engine can examine the fields of the form displayed on screen shot 400 to determine if the field has already be completed by the platform. If so, the flipping engine will not alter the form field. Information that can be automatically completed by the TRACTORHOUSE.COM platform may include the following fields: company name 428; company address 430; location of product city 434A; location of product state 434B; location of product country 434C; location of product zip code 434D; and currency 462. Some or all of this information can also be provided by the user as user profile information in the flipping engine. In some embodiments, the user profile information can take precedence over the automatically completed information and thus, the user can override the automatically filled in fields. Thus, if a user acquires a product in one location, the location information may be entered in the user profile and then populated into the screen shot 400 form rather than using the user's default address.

In some embodiments, such as one that could be utilized for the present example, the information required to list the product may simply not be available at the time the product is ready to be listed on the destination platform 206. In such a situation, the flipping engine can either solicit the information from the user and/or simply put placeholders into the form. As an example, the flipping engine may be configured to contact the user through various techniques such as an email message, a page, an automated phone call or even a manned phone call, and request the user to provide particular information. As another example, the flipping engine may simply populate the field with placeholder information, such as “TBD”, “Call Seller”, “unknown” or simply leave the form blank until the user accesses the system and completes the form. In the illustrated example, fields that may require interaction with the user include: location of product city 434A; location of product state 434B; location of product country 434C; location of product zip code 434D; condition 414; hours 450; brief description 456; detailed description 458; and price 460.

FIG. 5 is a screen shot 500 of a product listed on TRACTORHOUSE.COM that could be the result of flipping a product as described above, or as described below in conjunction with an alternate embodiment of the invention. In the screen shot, various fields of information are presented to parties accessing the website and conducting a search that lands on the particular product.

FIG. 5 includes a main field to categorize the products by manufacturer 502A. The screen shot 500 then includes a window to provide equipment specifications which includes the year that the product was manufactured 504A, the manufacturer 503B, the model 518A, the price 510, the location of the product 512, the condition of the product 514, the type of drive of the product 516 and the horse power 518.

In addition the screen shot 500 includes a window containing contact information for the seller 524. The contact information includes a company name 528, and address 534, a contact name 522B, a telephone number 530 and a fax number 532. The screen shot 500 also includes a general information block that contains general information about the product 526. Finally, the screen shot 500 also includes an area to automatically send an email to the seller by clicking on a hyper link that is populated with the year 504B, manufacturer 502C and model 508B of the product and the contact name of the seller 522A.

In a highly integrated embodiment of the present invention, the extraction and interjection processes can be fully automated and integrated into the acquiring platform and/or destination platform, or be facilitated by an external system. In this embodiment, the flipping engine can be distributed at various levels between the acquiring platform 202, the destination platform 206 and/or a stand-alone system. It should be appreciated that this embodiment of the invention can exist wholly in one of these listed components or distributed at various levels among two or more of the components. In a general embodiment, the flipping engine is predominantly located in an external component but, has some elements existing within the acquiring platform 202 and the destination platform 206.

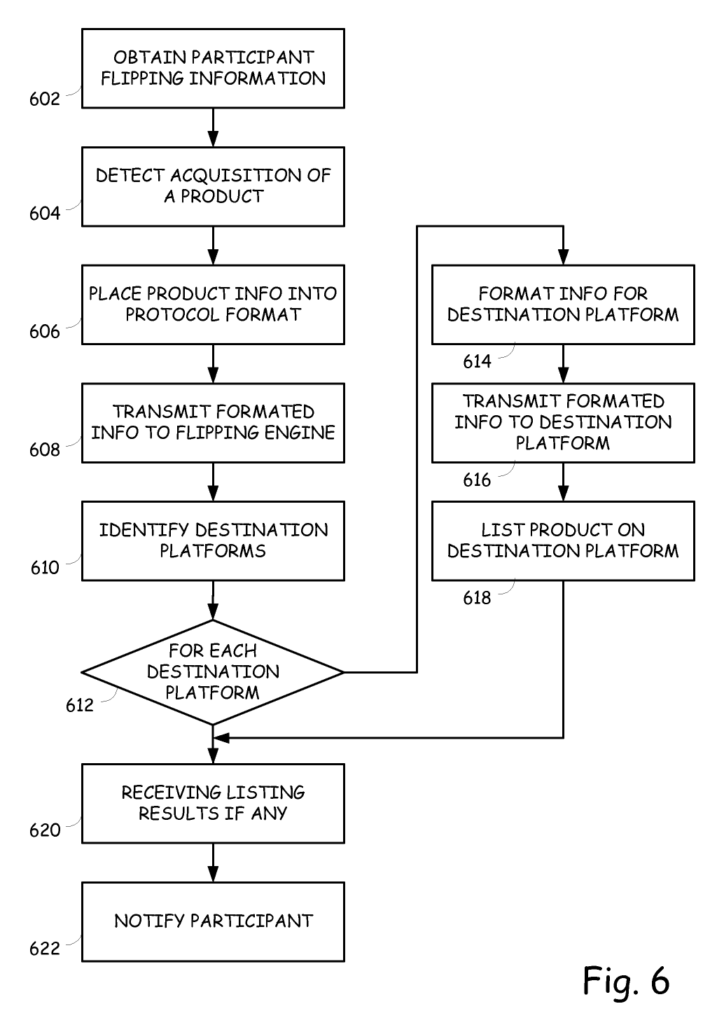

FIG. 6 is a flow chart diagram illustrating the general steps or processes involved in an exemplary embodiment of the present invention. It will be appreciated that the steps illustrated are for purposes of clarity and that the steps do not necessarily have to be conducted in the illustrated order, or in accordance with the described lines of demarcation. In fact, additional steps could be broken out of the illustrated steps or some of the steps may be combined. Further, portions of a step may occur at one point in time and other portions after one or more other steps have been initiated or completed. Yet, it should also be appreciated that the actual embodiment presented may in and of itself be considered novel but, the present invention is not necessarily limited to the illustrated embodiment.

In this highly-integrated embodiment, the acquiring platform 202 includes operational components necessary to provide as output, the relevant information regarding a product acquisition and the destination platform 206 includes operational components necessary to receive input information about an available product and then list that product. More specifically, flipping information is obtained from a participant 602. This information may be solicited by a stand-alone component of the flipping engine or may be solicited by the acquiring and/or destination platforms. Regardless, some component of the system needs to obtain knowledge regarding the flipping desires of the participant.

In one embodiment, this information is provided to the acquiring platform. In this embodiment, as a user registers with the acquiring system, such as an internet based auctioning system, the participant identifies his or her wishes regarding the flipping of the product. This information may simply state that all products won by the bidder are to be flipped and provide a destination for the communication of product information or the information may identify specific actions to take for specific products or classes of products.

If a product is won or acquired by the participant, the acquisition platform detects such an acquisition 604. If the product is to be flipped based on the participant flipping information, then information about the product is formatted in accordance with a particular protocol 606. As previously described, the product description or descriptive elements can be obtained using a variety of techniques. Thus far screen scraping, internet based searching and user inquiry techniques have been described. Other techniques may also be employed such as maintaining a database of the product descriptions and accessing that database to obtain the necessary information. Similarly, a database of user profiles may also be maintained and accessible to the various components of the various embodiments of the invention.

The formatted information 606 can then be transmitted to the external component of the flipping engine 608. It will be appreciated that alternatively, the acquiring platform may simply send an acquisition notice to the external component of the flipping engine and the external component can then acquire the information from the acquiring system via a defined protocol. In one embodiment, the acquiring system may send an email to the stand-alone component of the flipping engine indicating that the product has been acquired. The email may include all of the specifics regarding the product or, as mentioned above may simply indicated that the product was acquired. Other techniques may also be used to communicate this information and although specific techniques may be considered novel, they are provided as non-limiting examples.

For acquired products, the destination platforms are identified 610. The information regarding the destination platforms can be provided in a variety of manners. In one embodiment, the user may identify the destination platform(s) by interfacing to the acquiring platform. This can be done on a product by product basis or for all products or classes of products. Alternatively, the acquiring platform may simply be instructed to send all or some of the acquired product to the stand-alone component of the flipping engine and the stand-alone component may house the information regarding the particular destination platforms. It will be appreciated that the selection of destinations may be conducted based on a variety of circumstances. For instance, one category of products may be routed to one destination platform while another category of products are routed to a different destination. The destination determination may also be based on time and date information. For instance, the product is seasonal, more destinations may be selected during a seasonally active time.

For each destination platform selected for a product 612, the information available for the product is formatted in a manner that is required or accepted by the destination 614. The formatted information is then transmitted to the destination platform 616. The destination platform then presents or lists the product on the destination platform 618.

Subsequently, if the listed item is bid on or purchased by someone using the destination platform 620, the user may be notified of such activity 622.

Thus, various embodiments, features and aspects of the present invention have been presented. In the most general sense, the various embodiments of the present invention allow a user to acquire products on one system and then to re-list those products for sale or auction on another system. The embodiments of the present invention can be rolled into a totally on-line system or can even be deployed in the traditional, non-networked based scenario. For instance, aspects of the present invention can be incorporated into an inventory control system in such a manner that once a company purchases product for resale, the products are automatically incorporated into their inventory and made available to purchasers. Those skilled in the art will appreciated that embodiments of the present invention can also be incorporated into hybrid environments. For instance, a library may automatically list a book as available for check out after purchasing the book through an online system such as amazon.com.

An exemplary embodiment of the present invention is to deploy the use of the invention to move product between two auctioning platforms. For instance, automotive auctions that include online components can be used to acquire product and then flip the product to another platform such as ebaymotors.com. Advantageously, embodiments of the present invention can create a seamless or nearly seamless operation for making purchased product rapidly available on one or more platforms. In addition, the present invention can be utilized for bidders that are present at the auction rather than operating on-line but still be functional to flip the products to either an online auction or store, or a normal, not networked based auction or store. The acquiring platforms and destination platforms can include any of a variety of platforms. A few non-limiting examples of acquiring platforms include online auctions, live in-person auctions, online stores, telephone orders, fax orders, orders placed through the use of interactive television, orders placed through cellular telephone orders, purchases made through a brick and mortar store, classified adds in newspapers of magazines, kiosk sales, and purchases made from advertisements. Similarly, any of these platforms may also be qualified as destination platforms. It should also be appreciated that the present invention may also be used to flip a product right back onto the same platform. For instance, an ebay shopper may purchase multiple products and have those products immediately available for auction again on the same site.

Although the various embodiments of the present invention may be described with reference to particular embodiments having various features, those skilled in the art will appreciate that the embodiments are simply non-limiting examples. Thus, the various embodiments may incorporate all or only a portion of the above-described features and aspects.

What is claimed is:

1. A method for reselling acquired products, the method comprising the steps of:
identifying descriptive elements of the acquired product;
formatting the descriptive elements in accordance with a destination platform;
transmitting the formatted descriptive elements to the destination platform; and
listing the acquired product as an available product on the destination platform.

2. The method of claim 1, further comprising the steps of:
receiving flipping profile information identifying qualified products for being flipped; and
detecting the acquisition of a qualifying product.

3. The method of claim 1, wherein the step of identifying descriptive elements of the acquired product further comprises scraping a displayed screen to obtain the descriptive elements.

4. The method of claim 3, wherein the step of identifying descriptive elements further comprises searching the Internet for further identifying information.

5. The method of claim 5, wherein the step of identifying descriptive elements further comprises soliciting information from the acquiring party.

6. The method of claim 1, wherein the step of identifying descriptive elements of the acquired product further comprises accessing a database containing product descriptive information.

7. The method of claim 1, wherein the step of formatting the descriptive elements in accordance with a destination platform further comprises the steps of:
formatting the information into a first format;
transmitting the first formatted information to an intermediary node; and
formatting the information into a second format, the second format being compatible with the destination platform.

8. The method of claim 7, wherein the step of transmitting the first formatted information to the intermediary node further comprises emailing the information to the intermediary node.

9. The method of claim 7, wherein the step of transmitting the first formatted information to the intermediary node further comprises the steps of:
sending an indication to the intermediary node that information pertaining to the acquired product is available;
receiving a request from the intermediary node for accessing the information; and
providing the information to the intermediary node in response to the received request.

10. The method of claim 1, wherein the step of transmitting the formatted descriptive elements to the destination platform further comprises sending an email message to the destination platform.

11. The method of claim 1, wherein the step of transmitting the formatted descriptive elements to the destination platform further comprises sending a message in accordance with a protocol compatible with the destination platform.

12. The method of claim 1, wherein the step of transmitting the formatted descriptive elements to the destination platform further comprises:
sending an indication to the destination platform that information pertaining to the acquired product is available;
receiving a request from the destination platform for accessing the information; and
providing the information to the destination platform in response to the received request.

13. A system for facilitating the re-listing of acquired products, the system comprising:
an acquiring platform interface;
a destination platform interface; and
a flipping engine operative to communicate with the acquiring platform through the acquiring platform interface and the destination platform through the destination platform interface, the flipping engine being operative to:
detect the acquisition of a product to be flipped;
obtain information about the acquired product from the acquiring platform interface;
format the information to be compatible with the destination platform; and
provide the formatted information to the destination platform interface.

14. The system of claim 13, wherein the flipping engine is further operative to obtain information about the acquired product by searching for manufacturer's information about the product through the Internet.

15. The system of claim 13, wherein the flipping engine is further operative to obtain information about the acquired product by soliciting input from a user.

16. The system of claim 13, wherein the flipping engine is further operative to set default values for unknown information about the product.

17. The system of claim 13, wherein the flipping engine is further operative to obtain information about the acquired product through a user profile.

18. The system of claim 13, wherein the flipping engine is further operative to obtain information about the acquired product from a database.

19. An apparatus for facilitating the flipping of products purchased on a first platform onto a second platform, the apparatus comprising:
an acquiring platform interface;
a destination platform interface; and
being operable to communicate with the acquiring platform through the acquiring platform interface and the destination platform through the destination platform interface to:
detect the acquisition of a product to be flipped;
obtain information about the acquired product from the acquiring platform interface;
augment the information by searching for manufacturer's information on the Internet and accessing user supplied information;
format the information to be compatible with the destination platform; and
provide the formatted information to the destination platform interface.

20. The apparatus of claim 19, wherein the apparatus further comprises a user profile for storing user supplied information pertaining to the flipping of products.
